(19) United States
(12) Patent Application Publication
(10) Pub. No.: US 2015/0264652 A1
(43) Pub. Date: Sep. 17, 2015

(54) LOW-POWER ALMOST BLANK SUBFRAME (ABS) IN HETEROGENEOUS NETWORKS

(71) Applicants: Lili ZHANG, Beijing (CN); Haiming WANG, Beijing (CN); Tero Heikki Matii HENTTONENT, Espoo (FI); Chunyan GAO, Beijing (CN); Erlin ZENG, Beijing (CN); Wei HONG, Beijing (CN); Na WEI, Beijing (CN); Wei BAI, Beijing (CN); Pengfei SUN, Beijing (CN)

(72) Inventors: Lili Zhang, Beijing (CN); Haiming Wang, Beijing (CN); Tero Heikki Matti Henttonen, Espoo (FI); Chunyan Gao, Beijing (CN); Erlin Zeng, Beijing (CN); Wei Hong, Beijing (CN); Na Wei, Beijing (CN); Wei Bai, Beijing (CN); Pengfei Sun, Beijing (CN)

(21) Appl. No.: 14/441,804

(22) PCT Filed: Nov. 16, 2012
(86) PCT No.: PCT/CN2012/084731

§ 371 Date: May 8, 2015

(51) Int. Cl. H04W 52/14; H04W 52/24; H04W 72/04; H04W 72/08

(52) U.S. Cl. CPC H04W 52/143; H04W 72/082; H04W 52/244; H04W 72/0446

(57) ABSTRACT

An aggressor access node in a heterogeneous network sends to a victim access node a pattern of transmit power for designated low-interference subframes (e.g., LP-ABSs). Utilizing feedback information collected from the victim node which quantizes interference seen by user equipments (UEs) which are allocated at least some of those subframes, the aggressor node selects whether and how much to adjust transmit power for subsequent such subframes, then sends to the victim node a pattern of the adjusted transmit power for those subsequent subframes (e.g., an enhancement to relative narrowband transmit power RNTP). The victim node sends to UEs the pattern of transmit power and respective resource allocations in those designated low-interference subframes; then derives interference level per UE in those subframes based on channel quality indications received from the respective UEs; and sends to the aggressor access node feedback information which quantizes the derived interference levels.

### TECHNICAL FIELD

The exemplary and non-limiting embodiments of this invention relate generally to wireless communication systems, methods, devices and computer programs, and more specifically relate to coordination among access nodes of a heterogeneous network to avoid or at least mitigate mutual interference.

### BACKGROUND

The radio environment has become more complex as different systems overlap and the need has arisen to coordinate among them for smart-phones and other types of user equipments (UEs) which communicate on multiple systems at once. Traditional hierarchical cellular arrangements are generically termed a macro network or macro cell, and within or near that macro cell is one or more other radio sub-environments such as a pico cell (operating what is sometimes termed an underlay network) or device-to-device communications. Such overlapping networks are often referred to as heterogeneous networks. The available radio spectrum is most efficiently employed when there is some coordination among these different radio networks.

FIG. 1 is a schematic diagram of such a heterogeneous network. There is a UE 20 within the larger coverage area of a macro eNB 22 in a conventional cellular arrangement. Nearby is a pico eNB 26 which is assumed to operate on at least some of the same frequency bands as the macro eNB 22. Currently it is assumed the best effective management of this radio environment centers on the macro eNB 22, for it can coordinate its transmissions so as not to interfere with the lower transmit power of the pico eNB 26 which is communicating with the illustrated UE 20. The end goal is to avoid interference as much as practical between communications among the pico eNB 26 and the UEs 20 under its control and communications between the macro eNB 22 and the UEs under its control. There are quite a few variations of this basic concept; there may be multiple pico cells within or at least overlapping with the same macro cell 22 such as is shown at FIG. 1 by the other pico cell 24 which enables cell range extension (CRE); the protected communications may be device-to-device (D2D) on radio resources allocated by either the macro eNB 22 or pico eNB 26; the pico eNB 26 may be a implemented as a remote radio head (RRH) of the macro eNB 22, and so forth.

The evolved Universal Terrestrial Radio Access Network system, sometimes termed Long Term Evolution (LTE or LTE-Advanced), has introduced in Release 10 a mechanism to mitigate interference in such a heterogeneous radio network environment, termed enhanced inter-cell interference coordination eICIC. Specifically, the macro eNB 22 will restrict itself in certain identified almost-blank subframes (ABS) to transmit nothing except the common reference signals used for measurements (and in some cases also essential control information like synchronization, paging, or system information) but never any unicast downlink user data. During these ABSs, transmissions by the pico eNB 26 are ‘protected’ in that transmissions from the macro eNB with its greater transmit power (hence larger geographic area of its cell) will not severely interfere with the lower power pico eNB 26 transmissions on link 23. If UE 20 is not attached to the pico eNB 26 it can measure the common reference signal which the macro eNB 22 transmits in the ABS and report its radio link measurement to the macro eNB 22 for mobility purposes.

The combined usage of eICIC with cell range expansion (CRE, such as via pico cell 24 in FIG. 1) in a heterogeneous network deployment is effective in improving the system and cell-edge throughput. The ABSs from the macro eNB 22 have essentially zero transmission power in the physical downlink control channel (PDCCH) and physical downlink shared channel (PDSCH) to mitigate the interference to the pico eNB's UEs with CRE. There is also a resource status mechanism which enables a pico eNB 26 to provide information in order to “aid the macro eNB designating ABS to evaluate the need for modification of the ABS pattern”. This means that the macro eNB 22 determines the ABS pattern adjustment based on the downlink (DL) ABS status information. Further details for this resource status mechanism may be seen at document R3-110516 by Nokia Siemens Networks, Qualcomm Incorporated, Samsung and Interdigital Communications entitled CR TO TS 36.423, “ENABLING REPORTING OF ABS RESOURCE STATUS FOR EICIC PURPOSES” [3GPP TSG-RAN WG3 Meeting #71; Taipei, Taiwan; 21-25 Feb. 2011]; document R3-110163 by Qualcomm Incorporated entitled “MORE ON RESOURCE STATUSREPORT FOR EICIC” [3GPP TSG-RAN WG3 Meeting #7lbis; Dublin, Ireland; 17-21 Jan. 2011]; and document R3-110498 by Ericsson, Qualcomm Incorporated, Nokia Siemens Networks, Alcatel-Lucent, Alcatel-Lucent Shanghai Bell, Samsung, InterDigital, NTT DoCoMo, Inc. and KDDI entitled CR TO TS 36.423, “INTRODUCTION OF X2 SIGNALLING SUPPORT FOR EICIC” [3GPP TSG-RAN WG3 Meeting #71; Taipei, Taiwan; 21-25 Feb. 2011]. The X2 interface referred to in the latter reference is a control and data interface directly between network access nodes such as the macro and pico eNBs of FIG. 1.

Further background in this regard can be seen at the specification 3GPP TS 36.814 V9.0.0 (2010-03); and at document R1-120023 by Huawei and HiSilicon entitled ANALYSIS OF FEASIBILITY AND STANDARD IMPACT OF REDUCED POWER ABS [3GPP TSG-RAN WG1 Meeting #68; Dresden, Germany; 6-10 Feb. 2012].

Recently the 3GPP group has further looked into supporting partial ABS in the time domain in the aggressor cell (the macro eNB in the deployment of eICIC explained for FIG. 1) transmitting with reduced power instead of with zero power. This is to allow the partial utilization of the ABS and to reduce the negative side effects of eICIC. As stated in document R1-122993 by ZTE, CMCC, Ericsson, Hitachi, Renesas Mobile Europe Ltd and ST-Ericsson entitled: WF ON X2 SIGNALLING FOR REDUCED POWER ABS FOR EICIC [3GPP TSG-RAN WG1 Meeting #69; Prague, Czech Republic; 21-25 May 2012], it is for further study how much power reduction can be allowed and what kind of additional assistance information is required for supporting this functionality. The teachings below describe how to judge the appropriate proportion and power value of low power ABS (LP-ABS), and detail what is appropriate assistance information, how to report it, and how to trigger its reporting.

### SUMMARY

The foregoing and other problems are overcome, and other advantages are realized, by the use of the exemplary embodiments of this invention.

In a first exemplary aspect of the invention there is a method for controlling an aggressor access node in a heterogeneous network. In this embodiment the method comprises: sending to a victim access node a pattern of transmit power for designated low-interference subframes; utilizing feedback information, collected from the victim access node and which quantizes interference seen by user equipments which are allocated at least some of the designed low-interference subframes, to select whether and how much to adjust transmit power for subsequent designated low-interference subframes; and sending to the victim access node a pattern of the adjusted transmit power for the subsequent designated low-interference subframes.

In a second exemplary aspect of the invention there is an apparatus comprising at least one processor; and at least one memory including computer program code. This apparatus is for controlling an aggressor access node in a heterogeneous network, and the apparatus may be the whole aggressor access node or one or more components thereof. In this embodiment the at least one memory and the computer program code is configured, with the at least one processor, to cause the apparatus at least to: send to a victim access node a pattern of transmit power for designated low-interference subframes; utilize feedback information, collected from the victim access node and which quantizes interference seen by user equipments which are allocated at least some of the designed low-interference subframes, to select whether and how much to adjust transmit power for subsequent designated low-interference subframes; and send to the victim access node a pattern of the adjusted transmit power for the subsequent designated low-interference subframes.

In a third exemplary aspect of the invention there is a computer readable memory tangibly storing a set of computer instructions that is executable by at least one processor. In this embodiment the set of executable computer instructions comprises: code for sending to a victim access node a pattern of transmit power for designated low-interference subframes; code for utilizing feedback information, collected from the victim access node and which quantizes interference seen by user equipments which are allocated at least some of the designed low-interference subframes, to select whether and how much to adjust transmit power for subsequent designated low-interference subframes; and code for sending to the victim access node a pattern of the adjusted transmit power for the subsequent designated low-interference subframes.

In a fourth exemplary aspect of the invention there is a method for controlling a victim access node in a heterogeneous network. In this aspect the method comprises: sending to user equipments a pattern of transmit power for designated low-interference subframes and respective resource allocations in the designated low-interference subframes; deriving interference level per user equipment in the designated low-interference subframes based on channel quality indications received from the respective user equipments; and sending to an aggressor access node feedback information which quantizes the derived interference level for at least some of the user equipments.

In a fifth exemplary aspect of the invention there is an apparatus comprising at least one processor; and at least one memory including computer program code. This apparatus is for controlling a victim access node in a heterogeneous network, and the apparatus may be the whole victim access node or one or more components thereof. In this aspect the at least one memory and the computer program code is configured, with the at least one processor, to cause the apparatus at least to: send to user equipments a pattern of transmit power for designated low-interference subframes and respective resource allocations in the designated low-interference subframes; derive interference level per user equipment in the designated low-interference subframes based on channel quality indications received from the respective user equipments; and send to an aggressor access node feedback information which quantizes the derived interference level for at least some of the user equipments.

In a sixth exemplary aspect of the invention there is a computer readable memory tangibly storing a set of computer instructions that is executable by at least one processor. In this aspect the set of computer instructions comprises: code for sending to user equipments a pattern of transmit power for designated low-interference subframes and respective resource allocations in the designated low-interference subframes; code for deriving interference level per user equipment in the designated low-interference subframes based on channel quality indications received from the respective user equipments; and code for sending to an aggressor access node feedback information which quantizes the derived interference level for at least some of the user equipments.

### BRIEF DESCRIPTION OF THE DRAWINGS

FIG. 1 is a plan view of a conceptual radio environment in which the various exemplary embodiments of these teachings may be practiced to advantage.

FIG. 2 is an example signaling diagram which gives a broader context in which the information elements (IEs) of FIGS. 3, 4A-B and 5 may be signaled in a specific but non-limiting implementation.

FIG. 3, continuous FIGS. 4A-B, and FIG. 5 each illustrate different examples of a conventional ABS Status Information Element (IE) which is modified according to exemplary but non-limiting embodiments of these teachings to add the shaded regions which carry the feedback information detailed herein.

FIG. 6A is a logic flow diagram illustrating from the perspective of the aggressor access node or macro eNB the operation of a method, and a result of execution of computer program instructions embodied on a computer readable memory, for practicing exemplary embodiments of these teachings.

FIG. 6B is a logic flow diagram illustrating from the perspective of the victim access node or pico eNB the operation of a method, and a result of execution of computer program instructions embodied on a computer readable memory, for practicing exemplary embodiments of these teachings.

FIG. 7 is a simplified block diagram of some of the devices shown at FIG. 1 which are exemplary electronic devices suitable for use in practicing the exemplary embodiments of this invention.

### DETAILED DESCRIPTION

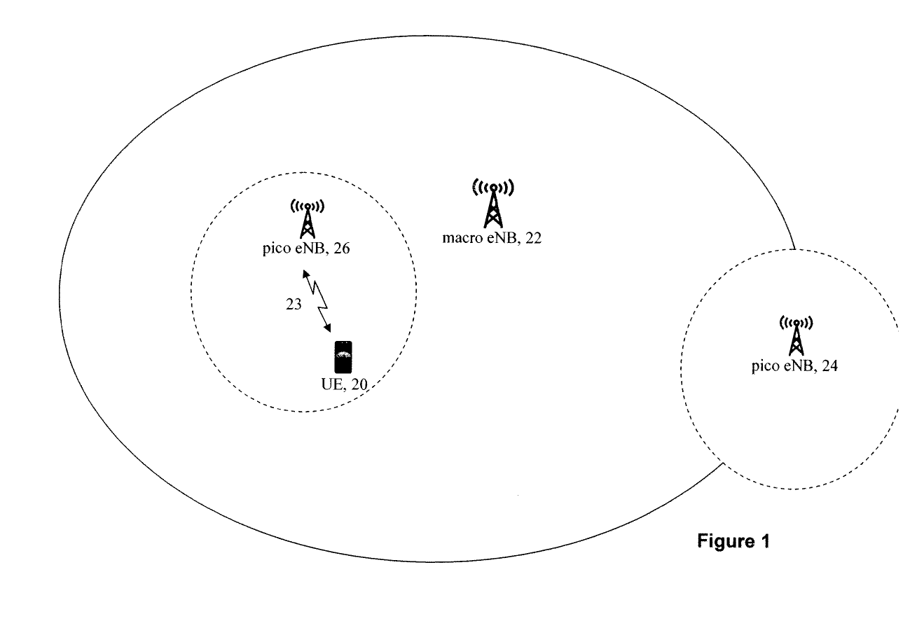

To improve the spectral utilization on reduced power ABSs, it is beneficial to provide the aggressor cell (e.g., the macro eNB 22) with the flexibility of adapting its ABS power to the CRE bias value rather than to make macro eNB set the same low power or zero power on configured ABSs. In this regard, 3GPP TS 36.814 details that when multiple victim eNBs are deployed under the same macro eNB coverage (as is shown at FIG. 1 with two pico eNBs 24, 26 under the same macro eNB 22), the macro eNB can set various transmit power levels on different ABSs based on some relevant information of each pico eNB. Such information can be for example the location information and the CRE bias value. This enables the macro eNB to make a reasonable tradeoff between the protection it affords for each pico cell and the resource efficiency of the macro cell itself. For this reason the macro eNB 22 should acquire this relevant information, which can also include the interference conditions of the different pico cells.

Additionally, since each of the traffic, the interference scenario and the CRE bias are time-varying, it is preferable to utilize information exchanged between the relevant pico eNB and its macro eNB rather than to use operations and maintenance (OAM) settings. In the LTE radio access technology there is an X2 interface between eNBs which can be used for this information exchange, but an X2 signalling enhancement is needed to fully utilize the reduced power ABS. In some practical deployments of a heterogeneous network there may be a large number of pico eNBs under a single macro eNB. FIG. 1 particularly illustrates the two pico eNBs that are at widely different distances from the same macro eNB to show that it may be advantageous to set different power levels for different LP-ABSs. For example, the LP-ABS1 with a lower transmit power level 1 can be used for resource protection at some close pico cell such as pico eNB 26, while ABS2 with a higher transmit power level 2 can be used for resource protection at the other far away pico cell(s) represented in FIG. 1 by pico eNB 24.

With the above considerations in mind, it is then important to know how to determine what is the recommended number as well as the value of transmit power levels 1 and 2. In addition to that quantitative solution, then given the limited power it needs to be determined how the interference between the macro and pico eNBs should be restricted so that the remaining transmission power of the victim UE 20 at the pico cell may support the data transmission, when applying the corresponding uplink transmission power control.

The teachings below resolve the reportable quantities for tolerable interference levels and UE assignments to subframe groups. In particular, the detailed examples below introduce new metrics for the victim cell feedback to facilitate the aggressor cell's determination of the appropriate transmission power level of a low-interference subframe (e.g., LP-ABS), where that determination seeks to maximize the utilization of the protected radio resource while ensuring an acceptable performance at the victim cell. While the examples below are in the specific context of a heterogeneous network operating according to the LTE radio access technology, LTE is not any limitation to how these teachings may be implemented for many radio access technologies are utilizing heterogeneous networks. The specific references below to X2 interface, eNB, and other names specific to LTE are therefore not limiting and apply equally to similar interfaces, entities, channels, etc. in other radio access technologies that may be know by different names.

More specifically, these teachings detail exemplary reportable quantities for tolerable interference levels and UE assignments to subframe groups. In particular, the pico eNB 26 reports the assistance information to facilitate the macro eNB 22 doing a low-interference subframe (e.g., LP-ABS) set and adjustment. The assistance information may include the acceptable interference level as well as the low-interference subframe status, and in some embodiments may further include the physical resource block (PRB) allocation in a certain low-interference subframe. The macro eNB 22 integrates these factors along with the local information to determine the corresponding number and transmission power level of low-interference subframes, as well as the PRB utilization, in order to maximize the resource utilization in the protected resource and to maximize energy efficiency.

To this end we define two new metrics: an acceptable interference level (AIL); and a low interference subframe status (LISS) of the classified highly interfered UEs 20. Based on these the macro eNB 22 can determine what is the appropriate transmission power level and the appropriate number of a corresponding level low-interference subframe.

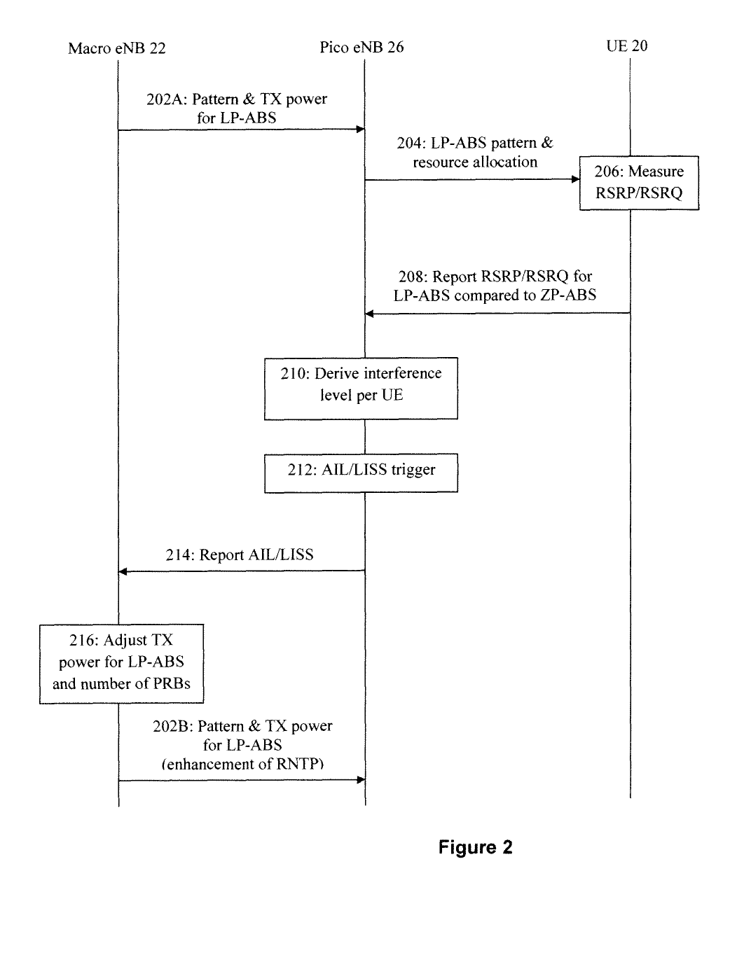

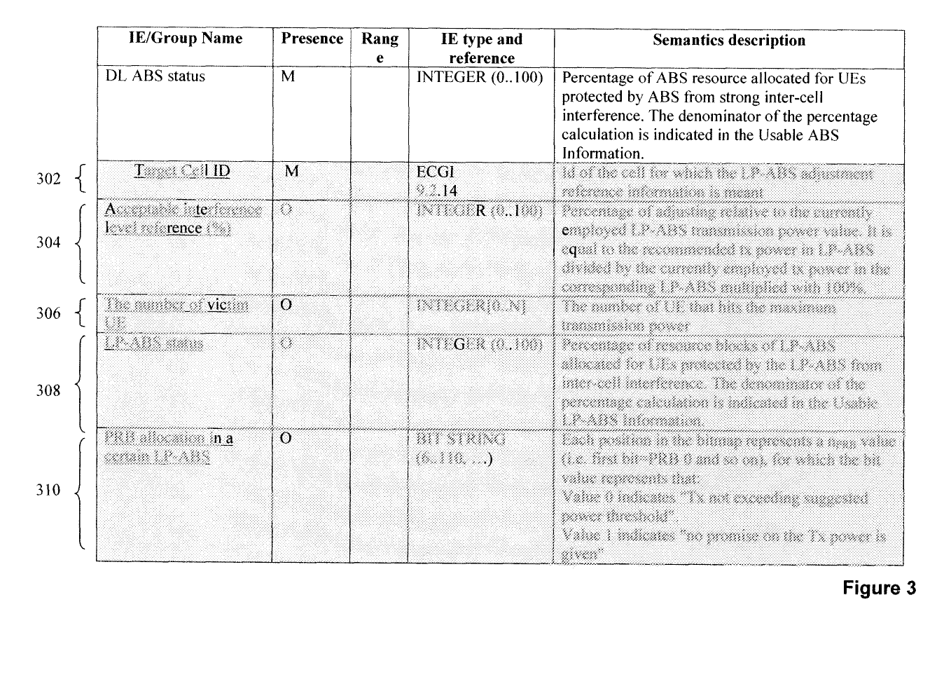

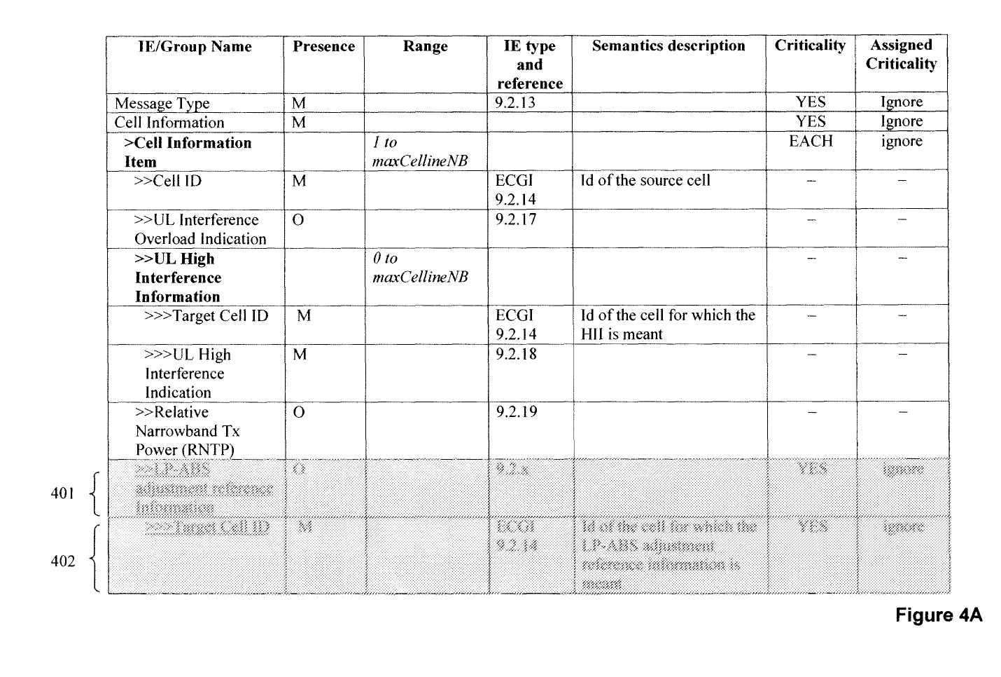

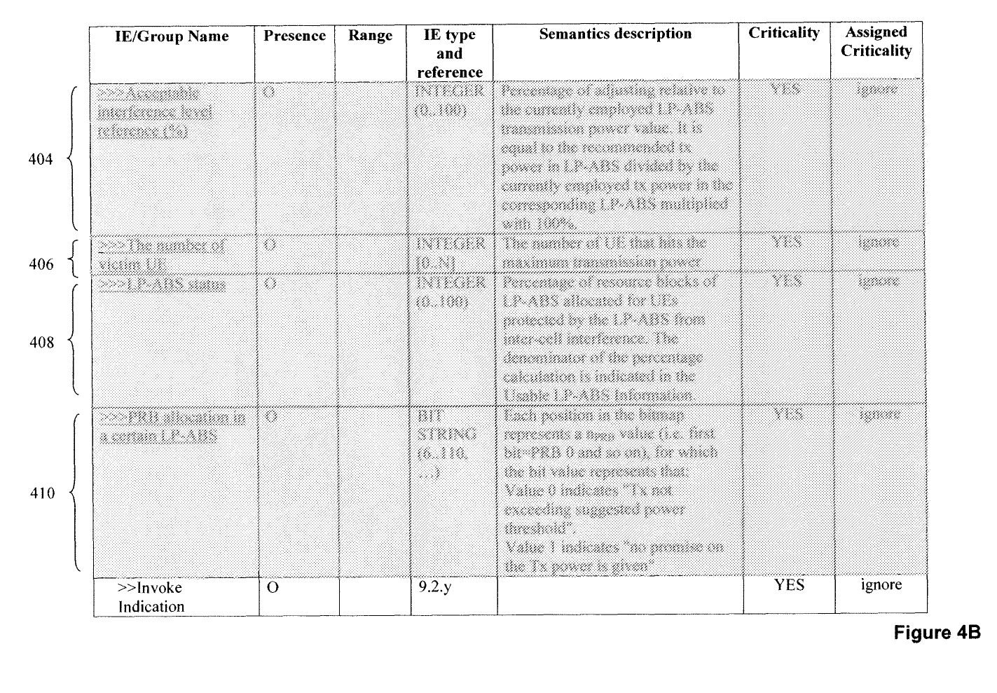

FIGS. 3, 4A-B and 5 illustrate different examples of a conventional ABS Status Information Element (IE) which is modified according to the shaded regions to carry this AIL and LISS information according to exemplary but non-limiting embodiments of these teachings. FIGS. 4A-B represent one continuous ABS Status IE modified accordingly. The “Presence” field in these figures indicates whether the corresponding information field (row) is mandatory (M) or optional (O) for inclusion in the ABS Status IE. For reference the conventional ABS Status IE is detailed more particularly at 3GPP TR 35.814 V9.0.0 (2010-03). FIG. 2 illustrates an example signaling diagram which gives a broader context in which these IEs and specific information fields may be signaled in a specific but non-limiting implementation.

First consider the acceptable interference level metric AIL. The AIL may be of different configurations with respect to the reported factors and the IEs shown at FIGS. 3 through 5 are only example implementations. In various embodiments the AIL may include one or more of the following:
The target cell ID for which the low-interference subframe adjustment is intended; this is shown at reference numbers 302, 402 and 502 of FIGS. 3, 4A and 5, respectively.
A percentage relative to the currently employed low-interference sub frame transmission power value, based on the tolerable interference level; this is shown at reference numbers 304, 404 and 504 of FIGS. 3, 4B and 5, respectively.
The number of UEs (or proportion of UEs) which hit the maximal power in a specific subframe; this is shown at reference numbers 306, 406 and 506 of FIGS. 3, 4B and 5, respectively.
The recommended low-interference subframe power level or the index of the corresponding power level, this is shown at reference number 401 of FIG. 4A.

The low-interference subframe status (LISS) metric may be considered to be an enhancement of the resource status report. The LISS in one example is defined as the percentage of physical resource blocks (PRBs) of low-interference subframe allocated for UEs that need to be protected by the low-interference subframe from inter-cell interference. In a specific embodiment the denominator of the percentage calculation is indicated in the usable low-interference subframe information. This is shown at reference numbers 308, 408 and 508 of FIGS. 3, 4B and 5, respectively.

Reporting of the AIL and the LISS by the pico eNB 26 to the macro eNB 22 may be triggered by the pico eNB 26 periodically, or even aperiodically based on some predefined events which are detailed below by example with respect to FIG. 2.

Respecting the PRB allocation, this can be defined in a certain level of low-interference subframe, that is, an enhancement of the relative narrowband transmit power (RNTP) by limiting it only to low-interference subframe in the corresponding level.

This enhancement of the RNTP respresents that the aggressor cell (macro eNB 22) keeps at least the corresponding percentage resource in the total PRB lower than the supposed power threshold, and leaves the remaining PRB unrestricted in the low-interference subframe of a certain level, with respect to the number of highly interfered UE 20 and traffic load of the victim cell 26. This is shown at reference numbers 310, 410 and 510 of respective FIGS. 3, 4B and 5.

The macro eNB 22 can notify the pico eNB 26 of this in the form of a certain pattern of transmit power levels in the different PRBs of the LP-ABSs that is semi-statically exchanged over the inter-eNB interface (2 in the LTE system). Such a pattern may be communicated for example as a bitmap of PRBs similar to the RNTP, together with the corresponding power level or threshold.

FIG. 2 is a signaling diagram illustrating one particular implementation of these teachings for the AIL/ALS feedback from the pico eNB 26 to the macro eNB 22. While this example uses the LTE-specific LP-ABS the general principles detailed there are readily extendable to any other type of low power/low interference subframe. FIG. 2 illustrates for one macro eNB 22, one pico 2NB 26, and one UE 20, but the reader will understand that the macro eNB 22 may be performing similar signaling for other pico eNBs under its coverage area and that each of the pico eNBs may have multiple UEs which are each receiving the LP-ABS transmit power pattern and resource allocation shown at FIG. 2, and also each UE which is allocated LP-ABS resources/PRBs will be reporting the measured reference signal received power (RSRP) and/or reference signal received quality (RSRQ) as shown in FIG. 1 for the singular UE 20.

Note also that alongside the LP-ABS patterns of PRB transmit powers the macro eNB 22 may also be protecting the pico eNB's communications with conventional (zero-power) ABSs. In practice these conventional ABSs may exhibit some marginal amount greater than zero power since some transmissions by the macro eNB are allowed in them (such as for example synchronization signals). Regardless, in the wireless arts the conventional ABSs in LTE/LTE-A are considered to be at zero-power from the macro eNB's transmission perspective and so the zero power (ZP)-ABS nomenclature is continued below with this conventional understanding.

FIG. 2 begins with the macro eNB 22 notifying at message 202A the adopted transmission power for a certain LP-ABS as well as LP-ABS pattern of various power levels to the pico eNB 26. The pico eNB 26 then derives at block 210 the interference level based on the RSRP/RSRQ measurement in a corresponding same-transmit-power level LP-ABS as compared with or relative to a ZP-ABS. The UE's RSRP/RSRQ measurement report is sent uplink at message 208.

Various levels of LP-ABS channel state information (CSI) measurement subframes or LP-ABS transmit power patterns need to be signaled to the victim UE 20 by the victim cell eNB/pico eNB 26 which is done at message 204 in FIG. 2. The UE's RSRP/RSRQ measurement and calculation at block 206 is done in these addressed measurement subframes 204 and the LP-ABSs correspondingly. In one particular embodiment the pico eNB 26 can use common (not dedicated) radio resource control (RRC) signaling for this purpose.

Having derived at block 210 the relevant feedback information for the macro eNB 22 to make appropriate adjustments to the pica eNB 26 and/or UE 20 transmit power, there are various ways to trigger the pico eNB 26 to report that feedback information in the AIL and LISS of the UEs that are classified as being highly interfered, from which the macro eNB determines what will be the appropriate transmission power level and number of a corresponding level LP-ABS. The pico eNB 26 can be triggered at block 212 to send these reports periodically, or they may be event driven. Some non-limiting examples of aperiodic event driven triggers for sending AIL feedback reports include the following:
upon the derived interference level being higher than a predefined threshold;
upon the power header room of the pico UE 20 being lower than another predetermined threshold;
upon some UE that needs ABS resource protection having a high buffer status report and a moderate power header room; and
the amount (or percentage) of the supposed uplink transmission power increment needed for sufficiently reliable data reception given the current LP-ABS interference, as compared with uplink transmission power in an ABS subframe free from interference, exceeding a predefined threshold.

An example of an aperiodic event driven trigger for sending LISS feedback reports include the LISS being higher or lower than a predetermined threshold. However triggered, assume the pico eNB 26 reports the AIL and/or LISS information to the macro eNB 22 at message 214 of FIG. 2.

The macro eNB 22 then makes a decision at block 216 on whether to adjust the transmission power and what is the appropriate number and transmission power level that would maximize the LP-ABS resource utilization. The macro eNB 22 does this by integrating all the feedback that the victim cell/pico eNB 26 reports for all of its corresponding UEs. For example, when both the macro eNB 22 and the pica eNB 26 are heavily loaded with traffic and therefore energy limited, the macro eNB 22 may compare the benefit of an adjustment to the transmit power level in the LP-ABSs and decide which one will bring forth better performance in terms of resource utilization efficiency, data throughput, and energy efficiency. In other words, the macro eNB 22 will seek in this heavily loaded scenario to prolong the victim UE 20 lifetime in regards to a sufficient number of LP-ABSs in which it will encounter sufficiently low interference.

As shown in field 401 of FIG. 4A, in an embodiment the pico eNB 26 may suggest the PRB allocation in a certain transmit power level of the LP-ABS, for example in the form of an enhanced RNTP format and with the corresponding recommended power level. The macro eNB 22 can use this more granular feedback information to execute correspondingly to decide the maximal resource utilization effectiveness upon acquiring the interference level from the pico eNB 26, and also at fields 304, 404 and 504 (of FIGS. 3, 4B and 5, respectively) the percentage of the resource that needs to do such an adjustment.

Assuming there is some adjustment to the allowed transmit power in the LP-ABSs, the macro eNB 22 then sends the new pattern and transmit power for the next subsequent LP-ABSs at message 202B of FIG. 2, similar to message 202A. After that the general signaling and processing shown in FIG. 2 repeat.

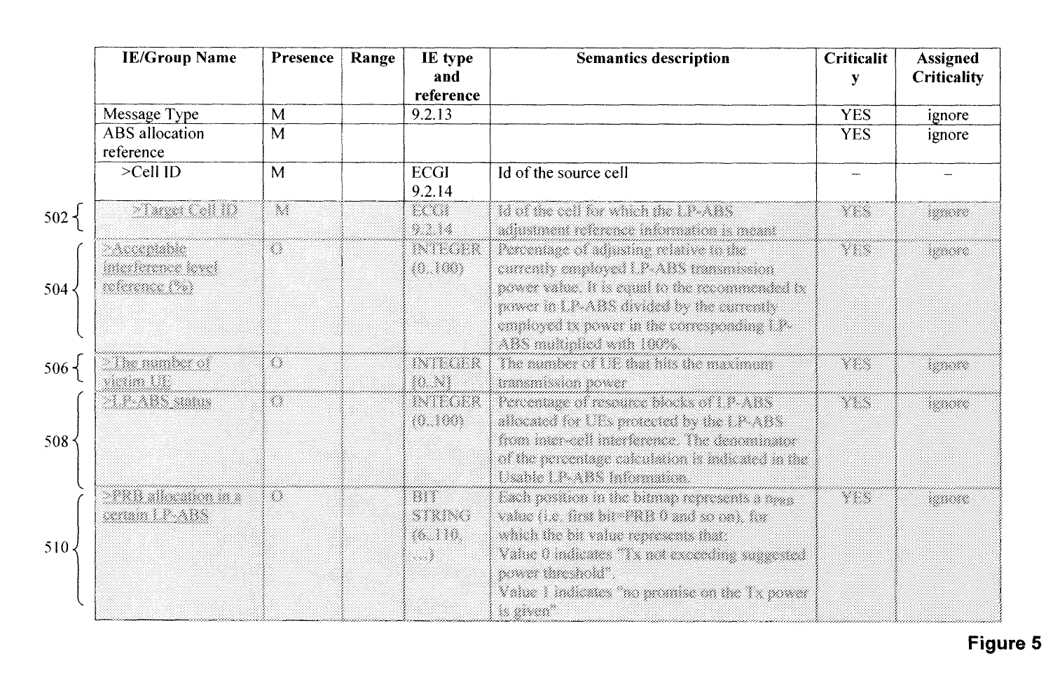

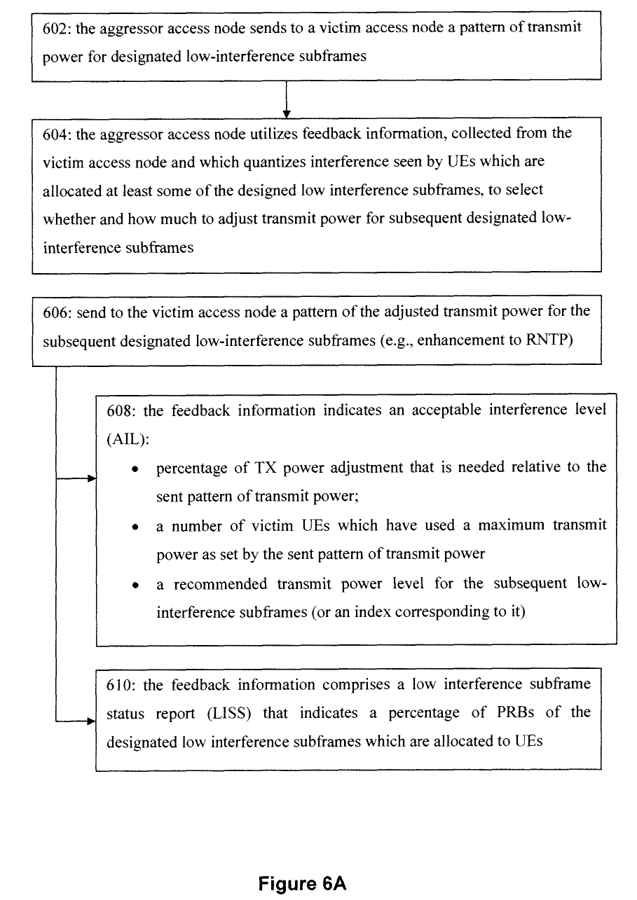

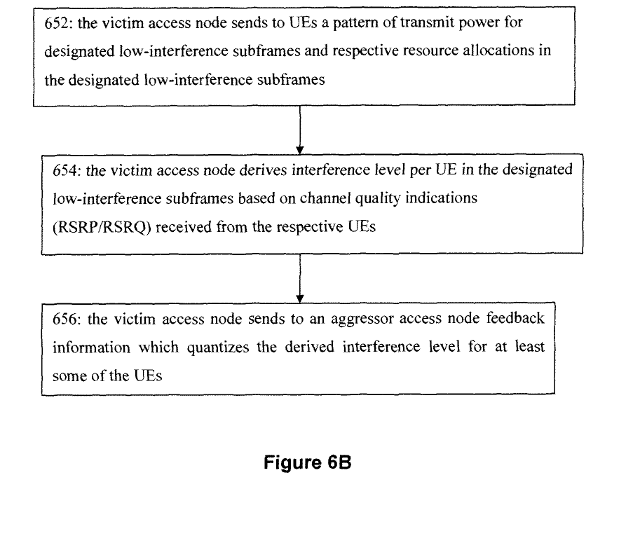

FIG. 6A-B are logic flow diagrams which each may be considered to illustrate the operation of a method, and a result of execution of a computer program stored in a computer readable memory, and a specific manner in which components of an electronic device are configured to cause that electronic device to operate. The various blocks shown in each of FIGS. 6A-B may also be considered as a plurality of coupled logic circuit elements constructed to carry out the associated function(s), or specific result of strings of computer program code stored in a memory.

Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

FIG. 6A details particular exemplary embodiments of the invention from the perspective of the aggressor/macro eNB 22. FIG. 6A may be implemented by the entire macro eNB 22 or by one or more components thereof, more generally termed an apparatus. At block 602 of FIG. 6A the aggressor access node (the macro eNB 22 in the above examples) sends to a victim access node (the pico eNB in the above examples) a pattern of transmit power for designated low-interference subframes. Then at block 604 the macro eNB utilizes feedback information, collected from the victim access node and which quantizes interference seen by user equipments which are allocated at least some of the designed low-interference subframes, to select whether and how much to adjust transmit power for subsequent designated low-interference subframes. The aggressor access node then sends to the victim access node at block 606 a pattern of the adjusted transmit power for the subsequent designated low-interference subframes. This is the enhancement to the RNTP that is detailed in the above examples more particularly.

Further portions of FIG. 6A are optional and may or may not be combined with one another in various embodiments. Block 608 specifies that the feedback information indicates an acceptable interference level. In the examples above this was the AIL, which quantizes the acceptable interference level as either a percentage of transmit power adjustment that is needed relative to the sent pattern of transmit power; and/or as a number of victim user equipments which have used a maximum transmit power as set by the sent pattern of transmit power, or a recommended transmit power level for the subsequent low-interference subframes (or an index corresponding to this recommended power level). In various embodiments any one or more than one of these may be indicated in the AIL.

Block 610 reviews the LISS. In this case the feedback information comprises a low-interference subframe status report that indicates a percentage of physical resource blocks of the designated low-interference subframes which are allocated to user equipments that need to be protected by the designated low-interference sub frames from inter-cell interference.

The enhancement of the RNTP in one embodiment respresents that the aggressor access node (macro eNB in the above examples) keeps at least a corresponding percentage resource in the total PRBs lower than a supposed power threshold, and leaves remaining PRBs or that total unrestricted in the subsequent designated low-interference subframe of a given power level. In one particular but non-limiting embodiment the enhancement of the RNTP is sent to the victim access node (pica eNB in the above examples) as a bitmap pattern, together with the power threshold. That power threshold may be selected by the aggressor access node based on a threshold that is suggested by the victim access node, where such a suggestion is available to the aggressor access node.

FIG. 6B details particular exemplary embodiments of the invention from the perspective of the victim/pico eNB 26. FIG. 6B may be implemented by the entire pico eNB 26 or by one or more components thereof, more generally termed an apparatus. At block 652 of FIG. 6B the victim access node (the pico eNB 26 in the above examples) sends to user equipments a pattern of transmit power for designated low-interference subframes and respective resource allocations in the designated low-interference subframes. Then at block 654 it derives interference level per user equipment in the designated low-interference subframes based on channel quality indications received from the respective user equipments. Then at block 656 the victim access node sends to an aggressor access node feedback information which quantizes the derived interference level for at least some of the user equipments.

Specific examples of the feedback information are summarized at blocks 606 and 608 of FIG. 6A, but in this case the feedback information is sent by the victim access node (rather than received by the aggressor access node as in the perspective of FIG. 6A). Specific triggers for sending of the feedback information at block 656 are detailed above in the bulleted list for the AIL and in the subsequent paragraph for the LISS.

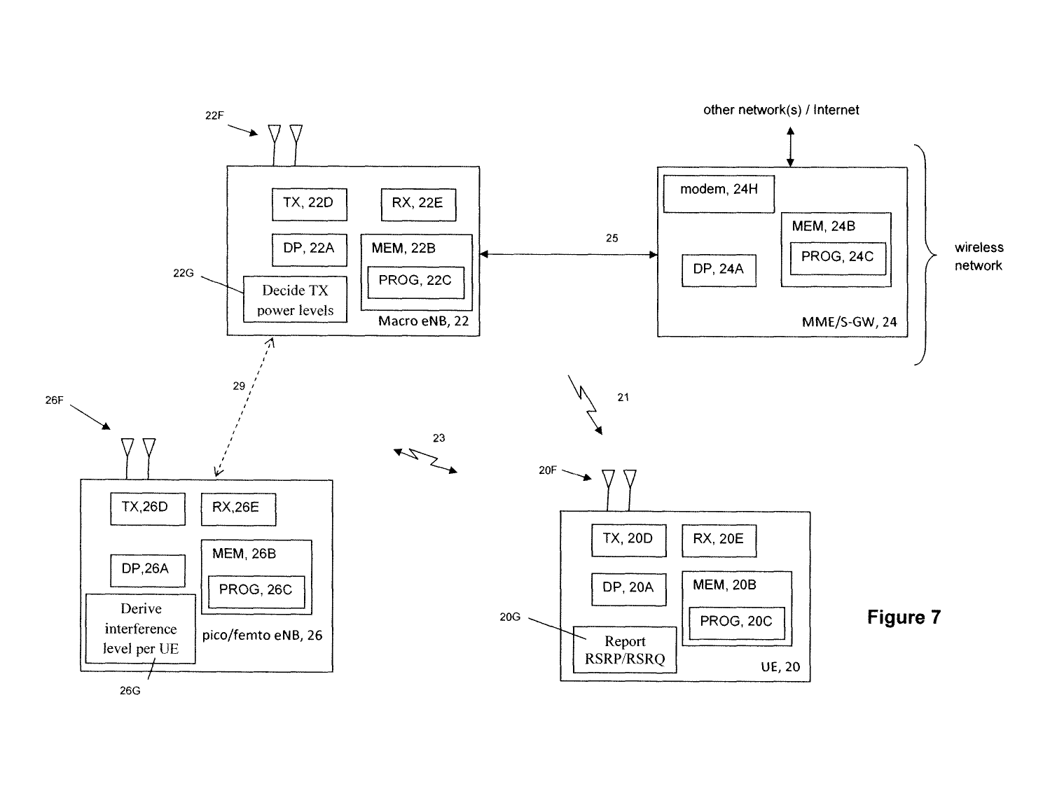

Reference is now made to FIG. 7 for illustrating a simplified block diagram of various electronic devices and apparatus that are suitable for use in practicing the exemplary embodiments of this invention. In FIG. 7 there is a first network access node/macro eNB 22 coupled via an X2 interface 29 to a second network access node/pico eNB 26 (or a femto eNB), which are adapted for communication over respective wireless links 21, 23 with an apparatus 20 such as a mobile terminal or termed more generally as a user equipment UE. The link between the macro eNB 22 and the UE 20 is shown as one way to indicate this is the link on which the UE 20 is likely to see interference on its allocated LP-ABSs. The first/macro eNB 22 may be further communicatively coupled via link 25 to further networks (e.g., a publicly switched telephone network PSTN and/or a data communications network/Internet), possibly via a higher network node such as a mobility management entity/serving gateway MME/S-GW 24 in the case of the LTE/LTE-A system.

The UE 20 includes processing means such as at least one data processor (DP) 20A, storing means such as at least one computer-readable memory (MEM) 20B storing at least one computer program (PROG) 20C, communicating means such as a transmitter TX 20D and a receiver RX 20E for bidirectional wireless communications with the pico eNB 26 via one or more antennas 20F. Within the memory 20B of the first UE 20 is also a computer program for measuring and reporting channel quality indications such as RSRP/RSRQ to the pica eNB 26 as detailed above for the various embodiments.

The first/macro eNB 22 also includes processing means such as at least one data processor (DP) 22A, storing means such as at least one computer-readable memory (MEM) 22B storing at least one computer program (PROG) 22C, and communicating means such as a transmitter TX 22D and a receiver RX 22E for bidirectional wireless communications with its associated user devices (not shown) via one or more antennas 22F and a modem. The macro eNB 22 has stored in its memory at 22G software to decide, based on the AIL and/or LISS feedback information, the transmit power levels for the next set of LP-ABSs as detailed in particular by the above non-limiting examples.

The pico eNB 26 is similarly functional with processing means such as at least one data processor (DP) 26A, storing means such as at least one computer-readable memory (MEM) 26B storing at least one computer program (PROG) 26C, and communicating means such as a transmitter TX 26D and a receiver RX 26E for bidirectional wireless communications with its associated user devices (for which only one is shown as UE 20) via one or more antennas 22F and a modem. The pico eNB 26 has stored in its memory at 26G software to derive the per-UE interference level based on the per-UE reported RSRP/RSRQ, and to quantize the interference level and in some embodiments also suggest to the macro eNB 22 a new transmit power level for the next subsequent LP-ABSs as detailed in particular by the above non-limiting examples.

For completeness the MME/S-GW 24 is also shown to include a DP 24A, and a MEM 24B storing a FROG 24C, and additionally a modem 24H for communicating with at least the first/macro eNB 22 and possibly also the pico eNB 26. While not particularly illustrated for the UE 20 or eNBs 22, 26, those devices are also assumed to include as part of their wireless communicating means a modem which may in one exemplary but non limiting embodiment be inbuilt on an RF front end chip so as to carry the respective TX 20D/22D/26D and RX 20E/22E/26E.

At least one of the PROGs 22C/22G, 26C/26G in the macro and eNB 22 and in the pico eNB 26 is assumed to include program instructions that, when executed by the associated DP 22A, 26A, enable the device to operate in accordance with the exemplary embodiments of this invention as detailed more fully above. In this regard the exemplary embodiments of this invention may be implemented at least in part by computer software stored on the MEM 22B, 26B which is executable by the DP 22A, 26A of the respective devices 22, 26; or by hardware; or by a combination of tangibly stored software and hardware (and tangibly stored firmware). Electronic devices implementing these aspects of the invention need not be the access node 22, 26, but exemplary embodiments may be implemented by one or more components of same such as the above described tangibly stored software, hardware, firmware and DP, or a system on a chip SOC or an application specific integrated circuit ASIC or a digital signal processor DSP or a modem or a subscriber identity module commonly referred to as a SIM card.

Various embodiments of the UE 20 can include, but are not limited to: cellular telephones; data cards, USB dangles, personal portable digital devices having wireless communication capabilities including but not limited to laptop/palmtop/tablet computers, digital cameras and music devices, and Internet appliances. Various embodiments of the eNBs 22, 26 may be a network base station/access node, a remote radio head, a relay, or one or more components of any of those implementations.

Various embodiments of the computer readable MEM 20B, 22B, 26B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPRQM and the like. Various embodiments of the DP 20A, 22A, 26A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the LTE and LTE-A systems, it should be appreciated that the exemplary embodiments of this invention are not limited for use with only this one particular type of wireless communication system, and that they may be used to advantage in other wireless communication systems such as for example UTRAN or other radio access technologies that now or in the future utilize a managed-interference subframe arrangement to implement a heterogeneous network.

Some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. A method for controlling an aggressor access node in a heterogeneous network, the method comprising:
sending to a victim access node a pattern of transmit power for designated low-interference subframes;
utilizing feedback information, collected from the victim access node and which quantizes interference seen by user equipments which are allocated at least some of the designed low-interference subframes, to select whether and how much to adjust transmit power for subsequent designated low-interference subframes; and
sending to the victim access node a pattern of the adjusted transmit power for the subsequent designated low-interference subframes.

2. The method according to claim 1, wherein the feedback information indicates an acceptable interference level and the pattern of the adjusted transmit power comprises an enhancement to relative narrowband transmit power RNTP.

3. The method according to claim 2, wherein the acceptable interference level indicates at least one of:
a percentage of transmit power adjustment that is needed relative to the sent pattern of transmit power;
a number of victim user equipments which have used a maximum transmit power as set by the sent pattern of transmit power; and
a recommended transmit power level for the subsequent designated low-interference subframe or an index of a power level corresponding thereto.

4. The method according to claim 1, wherein the feedback information comprises a low-interference subframe status report that indicates a percentage of physical resource blocks of the designated low-interference subframes which are allocated to user equipments that need to be protected by the designated low-interference subframes from inter-cell interference.

5. The method according to claim 2, wherein the enhancement of the RNTP respresents that the aggressor access node keeps at least a corresponding percentage resource in the total physical resource blocks lower than a power threshold, and leaves remaining physical resource blocks unrestricted in the subsequent designated low-interference subframe of a given power level.

6. The method according to claim 5, wherein the enhancement of the RNTP is sent to the victim access node as a bitmap pattern together with the power threshold.

7. The method according to claim 5, wherein the power threshold is selected by the aggressor access node based on a threshold suggested by the victim access node.

8. The method according to claim 1, wherein the aggressor access node is a macro eNB and the victim access node is a pico eNB.

9. An apparatus for controlling an aggressor access node in a heterogeneous network, the apparatus comprising:
at least one processor; and
at least one memory including computer program code;
in which the at least one memory and the computer program code is configured, with the at least one processor, to cause the apparatus at least to:
send to a victim access node a pattern of transmit power for designated low-interference subframes;
utilize feedback information, collected from the victim access node and which quantizes interference seen by user equipments which are allocated at least some of the designed low-interference subframes, to select whether and how much to adjust transmit power for subsequent designated low-interference subframes; and
send to the victim access node a pattern of the adjusted transmit power for the subsequent designated low-interference subframes.

10. The apparatus according to claim 9, wherein the feedback information indicates an acceptable interference level and the pattern of the adjusted transmit power comprises an enhancement to relative narrowband transmit power RNTP.

11. The apparatus according to claim 10, wherein the acceptable interference level indicates at least one of:
a percentage of transmit power adjustment that is needed relative to the sent pattern of transmit power;
a number of victim user equipments which have used a maximum transmit power as set by the sent pattern of transmit power; and
a recommended transmit power level for the subsequent designated low-interference subframes or an index of a power level corresponding thereto.

12. The apparatus according to claim 9, wherein the feedback information comprises a low-interference subframe status report that indicates a percentage of physical resource blocks of the designated low-interference subframes which are allocated to user equipments that need to be protected by the designated low-interference subframes from inter-cell interference.

13. The apparatus according to claim 10, wherein the enhancement of the RNTP respresents that the aggressor access node keeps at least a corresponding percentage resource in the total physical resource blocks lower than a power threshold, and leaves remaining physical resource blocks unrestricted in the subsequent designated low-interference subframe of a given power level.

14. The apparatus according to claim 13, wherein the enhancement of the RNTP is sent to the victim access node as a bitmap pattern together with the power threshold.

15. The apparatus according to claim 13, wherein the power threshold is selected by the aggressor access node based on a threshold suggested by the victim access node.

16. The apparatus according to claim 9, wherein the apparatus comprises the aggressor access node implemented as a macro eNB and the victim access node is a pico eNB.

17.-31. (canceled)

32. An apparatus for controlling a victim access node in a heterogeneous network, the apparatus comprising:
at least one processor; and
at least one memory including computer program code;
in which the at least one memory and the computer program code is configured, with the at least one processor, to cause the apparatus at least to:
send to user equipments a pattern of transmit power for designated low-interference subframes and respective resource allocations in the designated low-interference subframes;
derive interference level per user equipment in the designated low-interference subframes based on channel quality indications received from the respective user equipments; and
send to an aggressor access node feedback information which quantizes the derived interference level for at least some of the user equipments.

33. The apparatus according to claim 32, wherein the feedback information indicates an acceptable interference level.

34. The apparatus according to claim 33, wherein the acceptable interference level indicates at least one of:
a percentage of transmit power adjustment that is needed relative to the sent pattern of transmit power; and
a number of user equipments which have used a maximum transmit power as set by the sent pattern of transmit power; and
a recommended transmit power level for the designated subsequent low-interference subframes or an index of a power level corresponding thereto.

35. The apparatus according to claim 32, wherein the feedback information comprises a low-interference subframe status report that indicates a percentage of physical resource blocks of the designated low-interference subframes which were allocated to user equipments that need to be protected by the designated low-interference subframes from inter-cell interference.

36.-44. (canceled)
